(19) United States
(12) Patent Application Publication
(10) Pub. No.: US 2020/0027392 A1
(43) Pub. Date: Jan. 23, 2020

(54) DRIVING SYSTEM OF AMOLED DISPLAY PANEL AND AMOLED DISPLAY PANEL

(71) Applicant: SHENZHEN CHINA STAR OPTOELECTRONICS TECHNOLOGY CO., LTD., Shenzhen, Guangdong (CN)

(72) Inventor: Xiangyang XU, Shenzhen (CN)

(73) Assignee: SHENZHEN CHINA STAR OPTOELECTRONICS TECHNOLOGY CO.,LTD., Shenzhen, Guangdong (CN)

(21) Appl. No.: 16/322,064

(22) PCT Filed: Sep. 13, 2018
(86) PCT No.: PCT/CN2018/105436

§ 371 Date: Jan. 30, 2019

(30) Foreign Application Priority Data
Jul. 18, 2018 (CN) 201810789971.7

(51) Int. Cl. G09G 3/3225; G06K 9/00; G09G 3/3266

(52) U.S. Cl. CPC G09G 3/3225; G06K 9/0004; G09G 2354/00; G09G 2320/0626; G09G 2320/0686; G09G 3/3266

(57) ABSTRACT

The present disclosure discloses a driving system of an AMOLED display panel, which includes: a processor, a first test pixel group, a second test pixel group, a first brightness sensor, a second brightness sensor and a compensating driver, wherein the first brightness sensor detects brightness of the first test pixel group to obtain a first test pixel brightness, the second brightness sensor detects brightness of the second test pixel group to obtain a second test pixel brightness, the processor compares the first test pixel brightness and the second test pixel brightness with a pixel standard brightness respectively to obtain comparison results, and the compensating driver provides corresponding compensating voltages to all pixels included in a fingerprint identification region and a general display region respectively in response to the comparison results, so that all the pixels of the fingerprint identification region and the general display region display the pixel standard brightness.

### TECHNICAL FIELD

The present disclosure generally relates to the display technical field, more specifically to a driving system of an AMOLED display panel and the AMOLED display panel.

### BACKGROUND ART

An organic light emitting diode (OLED) display device has many advantages of self-luminescence, low driving voltage, high luminous efficiency, short response time, ultra thin, wide view angle, low power consumption, bendable and so on, which has been universally acknowledged in the industry as the most promising display device.

Compared with a liquid crystal display device TFT-LCD, an AMOLED (Active Matrix Organic Light Emitting Diode) further needs to use a driving thin film transistor in addition to need to use a switch thin film transistor, and the current generated by the driving thin film transistor at a saturation state drives the organic light emitting diode to emit light. At present, an existing pixel driving circuit used for the AMOLED is usually a “2T1C” circuit form architecture, that is, a structure of two thin film transistors plus one capacitor and one organic light emitting diode, as shown in FIG. 1, a “2T1C” pixel driving circuit includes a first thin film transistor T1, a second thin film transistor T2, a capacitor C and an organic light emitting diode OLED, the first thin film transistor T1 is the switch thin film transistor, the second thin film transistor T2 is the driving thin film transistor, and the capacitor C is a storage capacitor. Specifically, a gate of the first thin film transistor T1 is connected to a scan line Gate, a source thereof is connected to a data line Data, and a drain thereof is connected to a gate of the second thin film transistor T2, a source of the second thin film transistor T2 is connected to a power voltage Vdd, a drain thereof is connected to an anode of the organic light emitting diode OLED, a cathode of the organic light emitting diode OLED is connected to the ground, an end of the capacitor C is connected to the gate of the second thin film transistor T2, and another end thereof is connected to the anode of the organic light emitting diode OLED. The working process of the “2T1C” pixel driving circuit is divided into two stages: a first stage is that a scan signal Gate controls the first thin film transistor T1 to be turned on, a data signal Data enters the gate of the second thin film transistor T2 and the capacitor C through the first thin film transistor T1, the capacitor C is charged to a data signal voltage, and then the first thin film transistor T1 is turned off; and a second stage is that under the storage function of the capacitor C, a gate voltage of the second thin film transistor T2 still may be continuously maintained at the data signal voltage, such that the second thin film transistor T2 is in the turned on state, a driving current flows through the organic light emitting diode OLED, to drive the organic light emitting diode OLED to emit light.

A calculation formula of the current flowing through the organic light emitting diode OLED is:

I=K×(V_{dd}−Vₜₕ)² (1)

wherein I is the current flowing through the organic light emitting diode OLED, K is a constant coefficient, and depends on a channel size of the second thin film transistor T2, a dielectric coefficient of a gate insulating layer and a carrier mobility of a semiconductor material, Vₜₕ is a threshold voltage of the second thin film transistor T2, and V_{dd} is a power voltage.

A structural schematic diagram of an AMOLED display panel having a fingerprint identification region is shown in FIG. 2. As shown in FIG. 2, the AMOLED display panel having the fingerprint identification region includes the fingerprint identification region and a general display region. Since the fingerprint identification region is integrated with a fingerprint identification sensor circuit, a pixel luminous area of the fingerprint identification region is smaller than that of the general display region, that is to say, the pixel of the fingerprint identification region requires a greater driving voltage, and it can be known from formula 1 that the greater driving voltage is required, however, the greater the current flowing through the pixels of the fingerprint identification region is, and the more serious the brightness attenuation of the pixel of the fingerprint identification region is (as shown in FIG. 3, the greater the current is, the greater the brightness attenuation is). Thus, as the service life of the AMOLED display panel increases, a brightness difference between the fingerprint identification region and the general display region is more obvious, and this difference extremely affects the display effect of the screen.

### SUMMARY

On this account, an object of the present disclosure is to provide a driving system of an AMOLED display panel, so as to solve the a drawback of obvious brightness difference between the fingerprint identification region and the general display region in the existing AMOLED display panel having the fingerprint identification region by the driving system of the AMOLED display panel.

According to an aspect of exemplary embodiments of the present disclosure, there provides a driving system of an AMOLED display panel, the driving system which includes: a first brightness sensor, a second brightness sensor, a first test pixel group, a second test pixel group, a processor and a compensating driver, wherein the AMOLED display panel includes a display region and a non-display region, wherein the display region includes a fingerprint identification region and a general display region, wherein the fingerprint identification region and the general display region include a plurality of pixels arranged in a matrix, wherein the first brightness sensor detects a brightness of the first test pixel group to obtain a first test pixel brightness, the second brightness sensor detects a brightness of the second test pixel group to obtain a second test pixel brightness, the processor compares the first test pixel brightness and the second test pixel brightness with a pixel standard brightness respectively to obtain comparison results, and the compensating driver provides corresponding compensating voltages to all pixels included in the fingerprint identification region and the general display region respectively in response to the comparison results, so that all the pixels of the fingerprint identification region and the general display region display the pixel standard brightness.

Alternatively, the first test pixel group includes at least one first test pixel, the second test pixel group includes at least one second test pixel, wherein the number of the first test pixels included in the first test pixel group is the same as the number of the second test pixels included in the second test pixel group.

Alternatively, the first test pixel group is disposed in the fingerprint identification region, the second test pixel group is disposed in the general display region, or the first test pixel group is disposed in the non-display region adjacent to the fingerprint identification region, and the second test pixel group is disposed in the non-display region adjacent to the general display region.

Alternatively, the plurality of pixels arranged in a matrix included in the fingerprint identification region and the general display region, the first test pixel and the second test pixel include: a first thin film transistor, a second thin film transistor, a first capacitor, and an organic light emitting diode, wherein a gate of the first thin film transistor is connected to a scan line, a source thereof is connected to a data line, and a drain thereof is connected to a gate of the second thin film transistor, a source of the second thin film transistor is connected to a power voltage, a drain thereof is connected to an anode of the organic light emitting diode, a cathode of the organic light emitting diode is connected to the ground, an end of the first capacitor is connected to the gate of the second thin film transistor, and another end thereof is connected to the anode of the organic light emitting diode.

Alternatively, the compensating driver is internally installed with a compensation brightness-compensation voltage curve of the organic light emitting diode, determines a compensation brightness of the pixels of the fingerprint identification region and the general display region respectively based on the comparison results, and determines the compensation voltages corresponding to the compensation brightness of the pixels of the fingerprint identification region and the general display region respectively based on the compensation brightness-compensation voltage curve of the organic light emitting diode.

Alternatively, the compensation voltages are voltages for compensating data voltage.

The driving system of the AMOLED display panel provided according to the exemplary embodiment of the present disclosure is able to effectively solve the drawback of obvious brightness difference between the fingerprint identification region and the general display region in the AMOLED display panel.

### BRIEF DESCRIPTION OF THE DRAWINGS

The above and other purposes, features and advantages of the exemplary embodiments of the present disclosure will become more apparent, from the detailed descriptions taken in combination with the accompanying drawings below, and in which:

FIG. 1 illustrates a circuit diagram of the “2T1C” pixel circuit of the AMOLED display panel in the prior art;

FIG. 2 illustrates a structural schematic diagram of the AMOLED display panel having the fingerprint identification region in the prior art;

FIG. 3 illustrates a brightness attenuation contrast graph of the current-brightness of the organic light emitting diode in the AMOLED display panel in the prior art; and

FIG. 4 illustrates a block diagram of a driving system of the AMOLED display panel according to exemplary embodiments of the present disclosure.

### DETAILED DESCRIPTION

The exemplary embodiment of the present disclosure, an example of which is illustrated in the accompany drawings will now be referred to in detail, wherein the same reference numeral indicates the same part throughout the accompany drawings. The embodiment will be illustrated below with reference to the accompanying drawings, so as to explain the present disclosure.

FIG. 4 illustrates a block diagram of a driving system of the AMOLED display panel according to exemplary embodiments of the present disclosure.

As shown in FIG. 4, the driving system of the AMOLED display panel according to exemplary embodiments of the present disclosure includes: a first brightness sensor 10, a second brightness sensor 20, a first test pixel group 30, a second test pixel group 40, a processor 50 and a compensating driver 60, wherein the AMOLED display panel includes a display region and a non-display region, wherein the display region includes a fingerprint identification region 70 and a general display region 80, and wherein the fingerprint identification region 70 and the general display region 80 include a plurality of pixels arranged in a matrix.

Herein, with respect to disposition locations of the first test pixel group 30 and the second test pixel group 40, in an example, the first test pixel group 30 and the second test pixel group 40 may be disposed in the display region of the AMOLED display panel, for example, the first test pixel group 30 may be disposed in the fingerprint identification region 70, the second test pixel group 40 may be disposed in the general display region 80. In addition, in another example, the first test pixel group 30 and the second test pixel group 40 may be disposed in the non-display region of the AMOLED display panel, for example, the first test pixel group 30 may be disposed in the non-display region adjacent to the fingerprint identification region 70, the second test pixel group 40 may be disposed in the non-display region adjacent to the general display region 80.

Below, functions executed by the respective devices included in the driving system of the AMOLED display panel according to exemplary embodiments of the present disclosure will be described in details.

Specifically, the first brightness sensor 10 detects brightness of the first test pixel group 30 to obtain a first test pixel brightness, and the second brightness sensor 20 detects brightness of the second test pixel group 40 to obtain a second test pixel brightness.

As an example, the first test pixel group 30 may include at least one first test pixel, the second test pixel group 40 may include at least one second test pixel, wherein the number of the first test pixels included in the first test pixel group 30 is the same as the number of the second test pixels included in the second test pixel group 40. For example, when the first test pixel group 30 includes five first test pixels, the second test pixel group 40 includes five second test pixels as well.

Moreover, as an example, the first test pixel brightness may be a value obtained by the brightness of the first test pixel group 30 obtained through the first brightness sensor 10 being divided by the number of the test pixels included in the first test pixel group 30, and the second test pixel brightness may be a value obtained by the brightness of the second test pixel group 40 obtained through the second brightness sensor 20 being divided by the number of the test pixels included in the second test pixel group 40. For example, assuming that the first test pixel group 30 and the second test pixel group 40 each includes five test pixels, the first brightness sensor 10 may directly detect a total brightness of the five first test pixels, and the obtained the total brightness of the five first test pixels is divided by the number of 5 so as to obtain the first test pixel brightness; and the second brightness sensor 20 may directly detect a total brightness of the five second test pixels, and the obtained the total brightness of the five second test pixels is divided by the number of 5 so as to obtain the second test pixel brightness.

After the first test pixel brightness and the second test pixel brightness are obtained, the processor 50 compares the first test pixel brightness and the second test pixel brightness with a pixel standard brightness respectively to obtain comparison results.

Herein, the pixel standard brightness may be a preset optimum pixel gray scale value that matches user's visual perception. As an example, the processor 50 may calculate difference values between the first test pixel brightness and the second test pixel brightness with the pixel standard brightness, respectively, and obtain absolute values of the difference values. The absolute value of the difference value between the first test pixel brightness and the pixel standard brightness is used as a compensation brightness of the fingerprint identification region 70, and the absolute value of the difference value between the second test pixel brightness and the pixel standard brightness is used as a compensation brightness of the general display region 80. Meanwhile, the obtained compensation brightness of the pixels of the fingerprint identification region 70 and the general display region 80 is transmitted to the compensating driver 60 as the comparison results.

The compensating driver 60 provides corresponding compensation voltages to all the pixels included in the fingerprint identification region 70 and the general display region 80 respectively in response to the comparison result, so that all the pixels of the fingerprint identification region 70 and the general display region 80 display the pixel standard brightness.

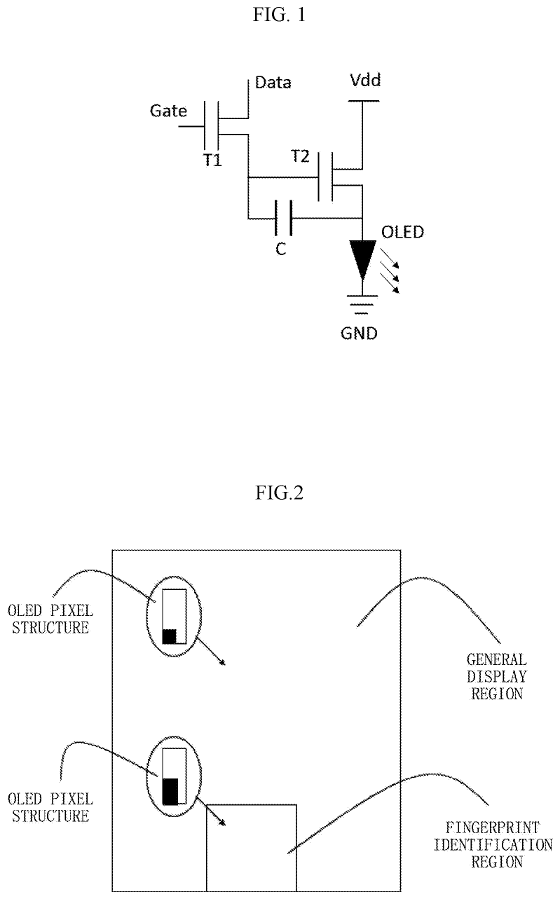

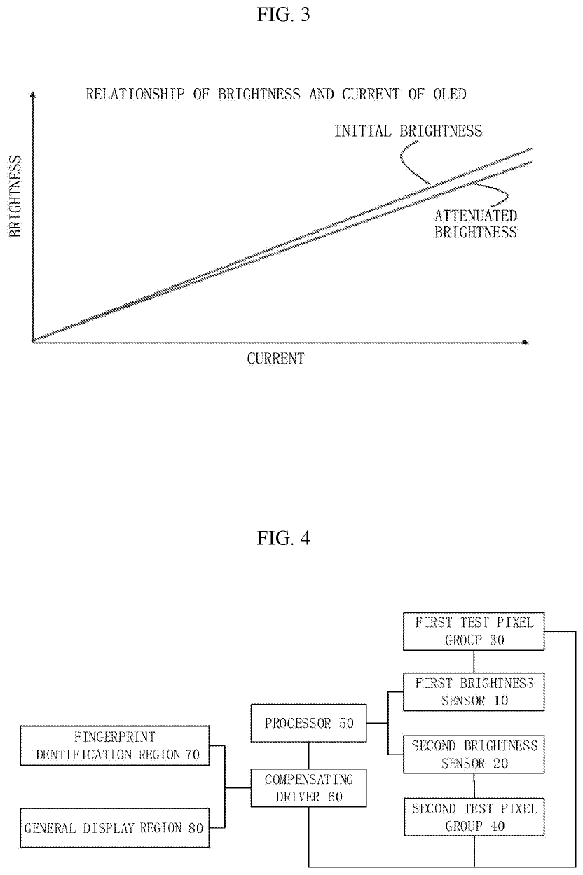

As an example, the compensating driver 60 may be internally installed with a non-volatile memory (not shown in FIG. 1), and the memory is stored with a compensation brightness-compensation voltage curve of the organic light emitting diode. The compensating driver 60 may determine the compensation brightness of the fingerprint identification region 70 and the general display region 80 respectively based on the received comparison result, and determine the compensation voltages corresponding to the compensation brightness of the pixels of the fingerprint identification region and the general display region respectively based on the compensation brightness-compensation voltage curve of the organic light emitting diode.

For example, following the above example, when the compensation brightness of the pixel of the fingerprint identification region 70 is 100 and the compensation brightness of the pixel of the general display region 80 is 120, it is possible to look up the compensation voltage when the compensation brightness of the pixel of the fingerprint identification region 70 is 100 and the compensation voltage when the compensation brightness of the pixel of the general display region 80 is 120 in the compensation brightness-compensation voltage curve.

Here, the plurality of pixels arranged in a matrix, included in the fingerprint identification region 70 and the general display region 80, the first test pixel and the second test pixel each includes: a first thin film transistor, a second thin film transistor, a first capacitor, and an organic light emitting diode (as shown in FIG. 1), wherein a gate of the first thin film transistor T1 is connected to a scan line Gate, a source thereof is connected to a data line Data, and a drain thereof is connected to a gate of the second thin film transistor T2, and a source of the second thin film transistor T2 is connected to a power voltage Vdd, a drain thereof is connected to an anode of the organic light emitting diode OLED, and a cathode of the organic light emitting diode OLED is is connected to the ground, an end of the first capacitor C is connected to the gate of the second thin film transistor T2, and another end thereof is connected to the anode of the organic light emitting diode OLED. Thus, according to a structure of the pixel, the compensation voltages may be voltages for compensating data voltage.

Here, it should be understood that the above obtained compensation brightness of the pixel of the fingerprint identification region 70 being 100 and the compensation brightness of the pixel of the general display region 80 being 120 are only exemplary, the compensation brightness of the pixel of the fingerprint identification region 70 and the compensation brightness of the pixel of the general display region 80 may also be other gray scale values, which are not restricted here.

In conclusion, in the driving system of the AMOLED display panel according to the exemplary embodiment of the present disclosure, it is able to compensate the driving current of pixels of the fingerprint identification region and the general display region in real-time, so that the brightness of the fingerprint identification region and the general display region in the AMOLED display panel may remain consistent as much as possible, so as to effectively solve the solve the drawback of obvious brightness difference between the fingerprint identification region and the general display region in the AMOLED display panel.

Apparently, the protection scope of the present disclosure is not limited to the above described detailed description, and those skilled in the art can make various modifications and variations to the present disclosure without departing from the spirit and scope of the present disclosure. So, if these modifications and variations of the present disclosure fall into the scope of the claims and the equivalent technologies thereof of the present disclosure, the present disclosure is also intended to include these modifications and variations.

What is claimed is:

1. A driving system of an AMOLED display panel, wherein the driving system comprises: a first brightness sensor, a second brightness sensor, a first test pixel group, a second test pixel group, a processor and a compensating driver, wherein the AMOLED display panel comprises a display region and a non-display region, wherein the display region comprises a fingerprint identification region and a general display region, wherein the fingerprint identification region and the general display region comprise a plurality of pixels arranged in a matrix, and
wherein the first brightness sensor detects brightness of the first test pixel group to obtain a first test pixel brightness, the second brightness sensor detects brightness of the second test pixel group to obtain a second test pixel brightness, the processor compares the first test pixel brightness and the second test pixel brightness with a pixel standard brightness respectively to obtain comparison results, and the compensating driver provides corresponding compensating voltages to all pixels comprised in the fingerprint identification region and the general display region respectively in response to the comparison results, so that all the pixels of the fingerprint identification region and the general display region display the pixel standard brightness.

2. The driving system of claim 1, wherein the first test pixel group comprises at least one first test pixel, the second test pixel group comprises at least one second test pixel, and wherein the number of the first test pixels comprised in the first test pixel group is the same as the number of the second test pixels comprised in the second test pixel group.

3. The driving system of claim 1, wherein the first test pixel group is disposed in the fingerprint identification region, the second test pixel group is disposed in the general display region, or the first test pixel group is disposed in the non-display region adjacent to the fingerprint identification region, and the second test pixel group is disposed in the non-display region adjacent to the general display region.

4. The driving system of claim 2, wherein the plurality of pixels arranged in a matrix comprised in the fingerprint identification region and the general display region, the first test pixel and the second test pixel comprise: a first thin film transistor, a second thin film transistor, a first capacitor and an organic light emitting diode, and
wherein a gate of the first thin film transistor is connected to a scan line, a source thereof is connected to a data line, and a drain thereof is connected to a gate of the second thin film transistor, a source of the second thin film transistor is connected to a power voltage, a drain thereof is connected to an anode of the organic light emitting diode, a cathode of the organic light emitting diode is connected to the ground, an end of the first capacitor is connected to the gate of the second thin film transistor, and another end thereof is connected to the anode of the organic light emitting diode.

5. The driving system of claim 1, wherein the compensating driver is internally installed with a compensation brightness-compensation voltage curve of the organic light emitting diode, determines a compensation brightness of the pixels of the fingerprint identification region and the general display region respectively based on the comparison results, and determines the compensation voltages corresponding to the compensation brightness of the pixels of the fingerprint identification region and the general display region respectively based on the compensation brightness-compensation voltage curve of the organic light emitting diode.

6. The driving system of claim 1, wherein the compensation voltages are voltages for compensating data voltage.

7. An AMOLED display panel, comprising a driving system, wherein the driving system comprises: a first brightness sensor, a second brightness sensor, a first test pixel group, a second test pixel group, a processor and a compensating driver, wherein the AMOLED display panel comprises a display region and a non-display region, wherein the display region comprises a fingerprint identification region and a general display region, wherein the fingerprint identification region and the general display region comprise a plurality of pixels arranged in a matrix, and
wherein the first brightness sensor detects brightness of the first test pixel group to obtain a first test pixel brightness, the second brightness sensor detects brightness of the second test pixel group to obtain a second test pixel brightness, the processor compares the first test pixel brightness and the second test pixel brightness with a pixel standard brightness respectively to obtain comparison results, and the compensating driver provides corresponding compensating voltages to all pixels comprised in the fingerprint identification region and the general display region respectively in response to the comparison results, so that all the pixels of the fingerprint identification region and the general display region display the pixel standard brightness.

8. The AMOLED display panel of claim 7, wherein the first test pixel group comprises at least one first test pixel, the second test pixel group comprises at least one second test pixel, wherein the number of the first test pixels comprised in the first test pixel group is the same as the number of the second test pixels comprised in the second test pixel group.

9. The AMOLED display panel of claim 7, wherein the first test pixel group is disposed in the fingerprint identification region, the second test pixel group is disposed in the general display region, or the first test pixel group is disposed in the non-display region adjacent to the fingerprint identification region, and the second test pixel group is disposed in the non-display region adjacent to the general display region.

10. The AMOLED display panel of claim 8, wherein the plurality of pixels arranged in a matrix comprised in the fingerprint identification region and the general display region, the first test pixel and the second test pixel comprise: a first thin film transistor, a second thin film transistor, a first capacitor and an organic light emitting diode, and
wherein a gate of the first thin film transistor is connected to a scan line, a source thereof is connected to a data line, and a drain thereof is connected to a gate of the second thin film transistor, a source of the second thin film transistor is connected to a power voltage, a drain thereof is connected to an anode of the organic light emitting diode, a cathode of the organic light emitting diode is connected to the ground, an end of the first capacitor is connected to the gate of the second thin film transistor, and another end thereof is connected to the anode of the organic light emitting diode.

11. The AMOLED display panel of claim 7, wherein the compensating driver is internally installed with a compensation brightness-compensation voltage curve of the organic light emitting diode, determines a compensation brightness of the pixels of the fingerprint identification region and the general display region respectively based on the comparison results, and determines the compensation voltages corresponding to the compensation brightness of the pixels of the fingerprint identification region and the general display region respectively based on the compensation brightness-compensation voltage curve of the organic light emitting diode.

12. The AMOLED display panel of claim 7, wherein the compensation voltages are voltages for compensating data voltage.
